(19) United States
(12) Patent Application Publication
(10) Pub. No.: US 2019/0251890 A1
(43) Pub. Date: Aug. 15, 2019

(54) IN CELL HYBRID DISPLAYS WITH REDUCED MURA AND METHODS FOR REDUCING MURA

(71) Applicant: CORNING INCORPORATED, CORNING, NY (US)

(72) Inventors: Xiaoju Guo, Painted Post, NY (US); Zhenhua Guo, Painted Post, NY (US); Jr-Nan Hu, New Taipei City (TW); Vitor Marino Schneider, Painted Post, NY (US); Elena Streltsova, Corning, NY (US); Ljerka Ukraincyyk, Ithaca, NY (US); Sujanto Widjaja, Palo Alto, CA (US)

(21) Appl. No.: 16/345,380

(22) PCT Filed: Oct. 31, 2017
(86) PCT No.: PCT/US2017/059179

§ 371 Date: Apr. 26, 2019

Related U.S. Application Data
(60) Provisional application No. 62/414,905, filed on Oct. 31, 2016.
(60) Provisional application No. 62/447,108, filed on Jan. 17, 2017.

(51) Int. Cl. G09G 3/20

(52) U.S. Cl. CPC G09G 3/2007; G09G 2320/066; G09G 2320/0276

(57) ABSTRACT

Disclosed herein are devices comprising a receive (RX) sensor layer, a transmit (TX) sensor layer, a cover glass, a polarizer, and at least one conductive element disposed on at least one surface of the cover glass, at least one surface of the polarizer, or both. Also disclosed herein are methods for reducing mura in a touch-display device.

### CROSS-REFERENCE TO RELATED APPLICATIONS

This application claims the benefit of priority under 35 U.S.C. § 119 of U.S. Provisional Application Ser. No. 62/447,108 filed on Jan. 17, 2017 and U.S. Provisional Application Ser. No. 62/414,905 filed on Oct. 31, 2016, the content of each is relied upon and incorporated herein by reference in its entirety.

### FIELD OF THE DISCLOSURE

The disclosure relates generally to in cell hybrid displays having reduced mura and methods for reducing mura in such displays, and more particularly to including a conductive layer to reduce mura caused by the build up of electrostatic charge.

### BACKGROUND

Displays with a thin film transistor (TFT) liquid crystal display (LCD) are commonly incorporated into touchscreen devices such as smartphones. TFT LCDs typically have liquid crystals, TFTs, a VCOM layer, and a color filter arranged between a color filter glass and a TFT array glass. A polarizer and a cover glass are also typically arranged above the color filter glass. One or more touch sensors may also be included in a display to provide combined touch and display functionality, referred to herein as a “touch-display” assembly, such as an LCD touch screen.

LCD touch screens can be arranged in various configurations, including “on cell,” “in cell,” or “hybrid in cell” configuration. In an on cell configuration the touch sensor is disposed on an outer surface of the color filter glass, e.g., a surface facing the user. In an in cell configuration the touch sensor is disposed within the cell, e.g., between the TFT array glass and the color filter glass. An in cell hybrid configuration can comprise receive (RX) sensor layers arranged in a y direction and transmit (TX) sensor layers arranged in the x direction. The RX sensor layer is disposed on an outer surface of the color filter glass and the TX sensor layer is combined with the VCOM layer and is disposed between the color filter glass and the TFT array glass. Thus an exemplary in cell hybrid display would at least include: a TFT array glass; TFTs disposed on the TFT array glass; the combined VCOM and TX sensor layer disposed on the TFTs; the liquid crystal layer disposed on the combined VCOM and TX sensor layer; the color filter disposed on the liquid crystal layer; the color glass filter disposed on the color filter; the RX sensors layer disposed on the color filter glass; a polarizer disposed on the RX sensors layer, and a cover glass disposed on the polarizer.

When static electricity is created on the cover glass bonded to in cell hybrid display, for example by moving a finger across the cover glass, and electrostatic energy builds up and creates an electric field between the RX sensors layer and the VCOM. Specifically, when the RX sensor layers include grounded functional RX sensor lines and dummy cosmetic RX sensor lines, the ungrounded dummy RX sensor lines create the electric field with the VCOM, which causes the liquid crystal to spin undesirably and causes mura or clouding. When the liquid crystal is aligned, it blocks the light and visible lines at the dummy RX sensor locations. However, when the liquid crystals spin undesirably as a result of the electric field between the dummy RX sensor lines and the VCOM, the lines become visible as the light is no longer blocked at those locations. As such, there is a need to solve the problem of this mura induced by electrostatic charge building up on the cover glass.

### SUMMARY

Disclosed herein are devices, such as in cell hybrid displays, designed to dissipate static electricity built up on a cover glass, wherein the devices include a cover glass, RX sensors, TX sensors, a polarizer, and at least one electrically conductive element. Also disclosed herein are cover glass assemblies comprising a cover glass sheet, an adhesive layer, an optional anti-fingerprint layer, and at least one electrically conductive element. Further disclosed herein are electronic devices comprising such devices or cover glass assemblies.

The disclosure relates, in various embodiments, to devices comprising a receive (RX) sensor layer, a transmit (TX) sensor layer, a cover glass, a polarizer positioned between the RX sensor layer and the cover glass, and at least one electrically conductive element disposed on at least one surface of the cover glass, at least one surface of the polarizer, or both. Also disclosed herein are methods for reducing mura in a touch-display device, the methods comprising positioning a polarizer between a cover glass and a receive (RX) sensor layer and applying at least one electrically conductive element to at least one surface of the cover glass, at least one surface of the polarizer, or both.

In non-limiting embodiments, the electrically conductive element can be disposed on a first major surface of the cover glass, a second major surface of the cover glass, at least one edge surface of the cover glass, portions thereof, and combinations thereof. The electrically conductive element may additionally or alternatively be disposed on a first major surface of the polarizer, a second major surface of the polarizer, at least one edge surface of the polarizer, portions thereof, and combinations thereof. According to additional embodiments, the at least one electrically conductive element may be chosen from conductive buffer layers, conductive ink layers, conductive gaskets, conductive polymer layers, conductive metal or metal oxide layers, and roughened surfaces. In yet further embodiments, the device may also comprise at least one of a thin film transistor array, a color filter, a color filter glass, and a liquid crystal layer. According to still further embodiments, the device may be a liquid crystal touch-display with an in cell hybrid configuration.

Additional features and advantages of the disclosure will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the various embodiments.

### BRIEF DESCRIPTION OF THE DRAWINGS

The following detailed description can be further understood when read in conjunction with the following drawings. Whenever possible, the same reference numerals will be used throughout the drawings to refer to the same or like parts.

FIG. 1 depicts an exemplary touch-display device;

FIGS. 2A-D depict a mechanism by which static electricity may develop mura in in cell hybrid displays;

FIGS. 3A-E depict assemblies comprising conductive elements according to various embodiments of the disclosure;

FIG. 4 is a graph illustrating dielectric constant (y axis) as a function of frequency (x axis) for cover glasses with different chemical compositions; and

FIG. 5 is a graph illustrating volume resistivity (y axis) as a function of temperature (x axis) for cover glasses with different chemical compositions.

### DETAILED DESCRIPTION

Disclosed herein are devices comprising a receive (RX) sensor layer, a transmit (TX) sensor layer, a cover glass, a polarizer positioned between the RX sensor layer and the cover glass, and at least one electrically conductive element disposed on at least one surface of the cover glass, at least one surface of the polarizer, or both. Also disclosed herein are methods for reducing mura in a touch-display device, the methods comprising positioning a polarizer between a cover glass and a receive (RX) sensor layer and applying at least one electrically conductive element to at least one surface of the cover glass, at least one surface of the polarizer, or both. Further disclosed herein are cover glass assemblies comprising a cover glass sheet, an adhesive layer, an optional anti-fingerprint layer, and at least one electrically conductive element. Still further disclosed herein are electronic devices comprising such devices or cover glass assemblies.

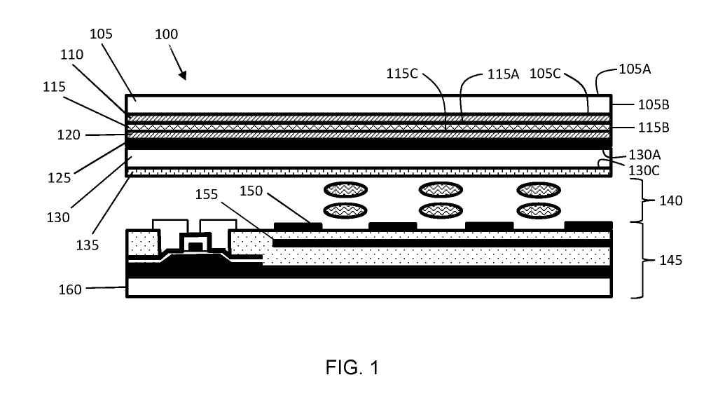

Various embodiments of the disclosure will now be discussed with reference to FIGS. 1-4, which illustrate various aspects of the disclosure. The following general description is intended to provide an overview of the claimed devices and methods, and various aspects will be more specifically discussed throughout the disclosure with reference to the non-limiting depicted embodiments, these embodiments being interchangeable with one another within the context of the disclosure.

FIG. 1 illustrates a non-limiting example of a display device 100 having an in cell hybrid configuration. The display device may include, for example, a cover glass 105, a polarizer 115, an RX sensor layer 125, a liquid crystal layer 140, and a TFT assembly 145. The cover glass 105 can include a first major surface 105A, a second major surface 105C, and at least one edge surface 105B. The polarizer 115 can likewise include a first major surface 115A, a second major surface 115C, and at least one edge surface 115B. In non-limiting embodiments, the display device 100 may be oriented such that the first major surfaces disclosed herein (105A, 115A, etc.) are forward-facing, e.g., facing toward a user, whereas the second major surfaces disclosed herein (105C, 115C, etc.) are rear-facing, e.g., facing toward the back of the device. Of course, the configuration illustrated in FIG. 1 is exemplary only and is not intended to be limiting on the appended claims.

The term “positioned between” and variations thereof is intended to denote that a component or layer is located between the listed components, but not necessarily in direct physical contact with those components. For instance, the polarizer 115 is positioned between the RX sensor layer 125 and cover glass 105 as illustrated in FIG. 1, but is not in direct physical contact with either of these layers. However, a component positioned between two listed components may also, in certain embodiments, be in direct physical contact with one or more of the listed components. As such, a component A positioned between components B and C may be in direct physical contact with component B, in contact with component C, or both.

In various embodiments, additional components and/or layers may be present in the display device 100. Referring again to the non-limiting embodiment depicted in FIG. 1, the display device 100 may include a first adhesive layer 110 positioned between cover glass 105 and polarizer 115. In various embodiments, first adhesive layer 110 may be in direct physical contact with both the cover glass 105 (e.g., second major surface 105C) and the polarizer 115 (e.g., first major surface 115A), such that a bond is formed between these components. A second adhesive layer 120 may also be positioned between the polarizer 115 and the RX sensor layer 125. According to non-limiting embodiments, the second adhesive layer may be in direct physical contact with both the polarizer 115 (e.g., second major surface 115C) and the RX sensor layer 125, such that a bond is formed between these components.

In the in cell hybrid configuration illustrated in FIG. 1, the RX sensor layer 125 may be disposed on the first major surface 130A of color filter glass 130. A color filter 135 may be disposed on the second major surface 130C of the color filter glass 130. The liquid crystal layer 140 may, in some embodiments, be positioned between the color filter glass 130 and the TFT assembly 145. The liquid crystal layer 140 may be in direct contact with the color filter 135 and the TFT assembly 145, or one or more optional components and/or layers may be present therebetween, such as adhesive layers and the like. An exemplary liquid crystal layer 140 may include any type of liquid crystal material arranged in any configuration known in the art, such as a TN (twisted nematic) mode, a VA (vertically aligned) mode, an IPS (in plane switching) mode, a BP (blue phase) mode, a FFS (Fringe Field Switching) mode, and an ADS (AdvancedSuper Dimension Switch) mode, to name a few.

The TFT assembly 145 can comprise various components and/or layers, such as a layer of individual pixel electrodes and a common voltage (VCOM) electrode layer shared by all pixels. In the illustrated in cell hybrid configuration, the transmit (TX) sensor layer 155 may also serve as the common voltage (VCOM) electrode layer and thus, may be interchangeably referred to herein as the TX/VCOM layer. Together with pixel electrodes 150, the TX/VCOM layer 155 can generate an electric field upon application of voltage across the electrodes. This electric field can determine the orientation direction of liquid crystal molecules in the liquid crystal layer 140. A TFT glass 160 may be used as a support for the various components of the TFT array.

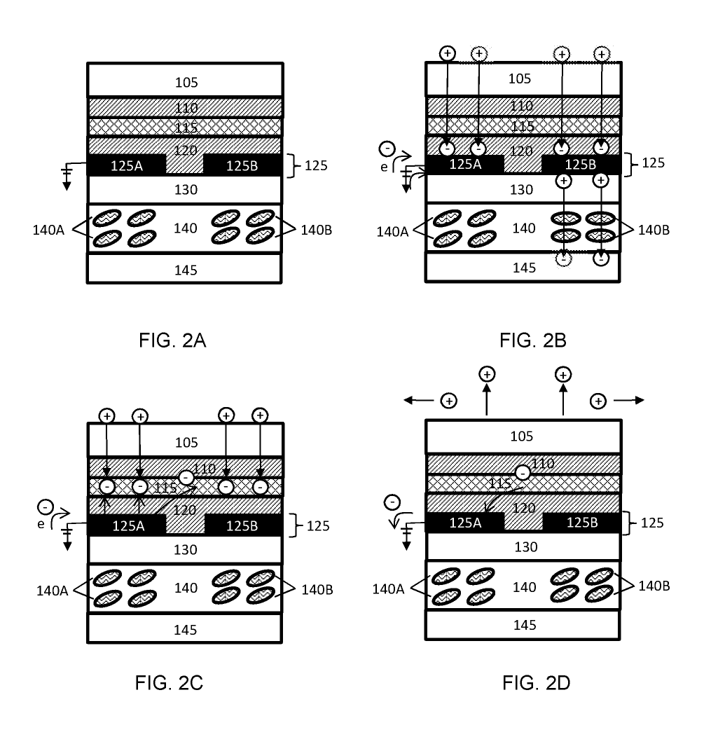

Referring now to FIGS. 2A-B, a mechanism is shown by which static electricity can develop mura in in cell hybrid display devices, with like numerals referencing like features depicted in FIG. 1. FIG. 2A depicts the display device in its initial state, e.g., prior to exposure to static electricity. RX sensor layer 125 is illustrated as comprising two subcomponents, functional RX sensor lines 125A and cosmetic or “dummy” RX sensor lines 125B. As shown in FIGS. 2A-2B, functional RX sensor lines 125 are electrically grounded, whereas cosmetic RX sensor lines 125B are not. When static electricity is created on the cover glass 105, for example, when a finger is moved across the cover glass, when a protective coating is peeled off the cover glass, or other like motions, an electrostatic charge may develop on the cover glass 105, shown as positive charges in FIG. 2B. Because the functional RX sensor lines 125A are grounded, excess charge on these lines may be quickly balanced or discharged by the transfer of electrons e to or from the ground. However, because the cosmetic RX sensor lines 125B are not grounded, these lines cannot balance the excess charge as quickly, which may result in an electric field between the cosmetic RX sensor lines 125B and the TX/VCOM layer (not illustrated) in the TFT assembly 145. As shown in FIG. 2B, this electric field may cause the liquid crystals 140B associated with cosmetic RX sensor lines 125B to temporarily spin out of alignment, causing mura or clouding. In contrast, the liquid crystals 140A associated with grounded functional RX sensor lines 125A will not undesirably spin out of alignment. Whereas the aligned liquid crystals 140A will block light such that the functional RX sensor lines 125A are not visible, the unaligned liquid crystals 140B will allow light to leak through, making the cosmetic RX sensor lines 125B temporarily visible to the user. The user may perceive, for example, cloudiness and/or color distortion in the regions of the display corresponding to the cosmetic RX sensor lines 125B.

Mura, or light leakage, caused by static electricity on the cover glass may persist until the electrostatic charge on the RX sensor layer is dissipated, e.g., until sufficient charge is transferred to or from the ground to neutralize the electrostatic charge in the display device, as shown in FIG. 2C. In FIG. 2D, the display device is shown in full recovery from the electrostatic charge event, with electrostatic charge removed from the cover glass sheet and any residual charge within the device balanced or discharged by the ground. To avoid the temporary period of liquid crystal misalignment depicted in FIG. 2B, it may be desirable to reduce, eliminate, or otherwise neutralize any electrostatic charge in the display device before such charge affects the RX sensor layer 125. In some embodiments, a conductive element may be disposed on the cover glass and/or disposed on the in cell hybrid touch panel to reduce static electricity. The conductive element may be chosen, for example, from a conductive buffer layer, a conductive ink layer, a conductive gasket, a conductive polymer layer, a conductive metal or metal oxide layer, and combinations thereof. Several different embodiments for reducing the build-up of static electricity, and the associated electrostatic charge, are discussed below.

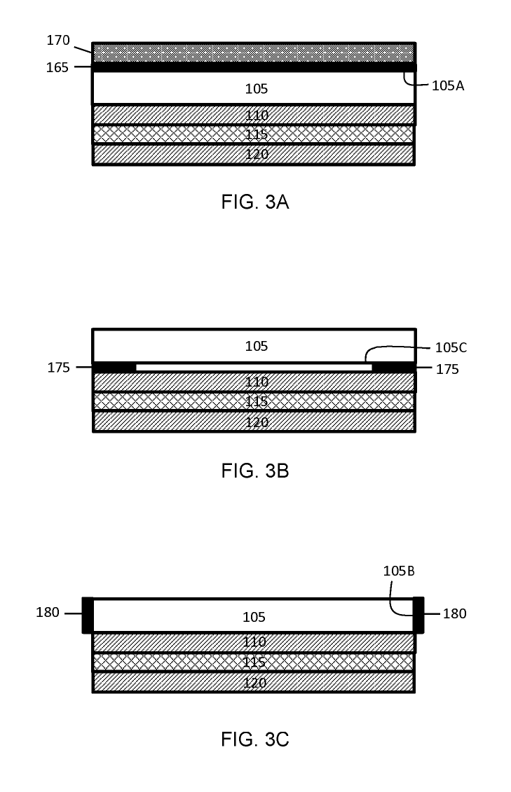

For illustrative purposes, FIGS. 3A-E depict cross-sectional views of the cover glass 105, first adhesive layer 110, polarizer 115, and second adhesive layer 120 of an exemplary display assembly. However, it is to be understood that the depicted embodiments can also comprise any other components and/or layers depicted in FIG. 1 or otherwise described herein, or any combination thereof without limitation. Embodiments of the disclosure will be discussed below with reference to FIGS. 3A-E.

In some embodiments, the cover glass may have a non-conductive anti-fingerprint coating. When a user's finger moves across the cover glass with the non-conductive anti-fingerprint coating, the static electricity builds up and cannot be quickly dissipated through the non-conductive anti-fingerprint coating. In some embodiments, the anti-fingerprint coating may include a buffer layer of SiO₂ and a flourosilane layer. One exemplary way to reduce mura is modify the buffer layer to increase the electrical conductivity, thereby enabling static electricity generated on the cover glass to spread across the cover glass surface through the conductive buffer layer. In some embodiments, the buffer layer may be modified to increase its electrical conductivity by adding impurities to the SiO₂ layer. In some embodiments, the impurities may include, but are not limited to, hydrogen or alkali metals, or combinations thereof. In some embodiments, the buffer may be modified to increase its electrical conductivity by reducing the oxygen content of pure SiO₂. In some embodiments, the buffer may be modified to increase its electrical conductivity by adding impurities and reducing the oxygen content.

In some embodiments, when an anti-fingerprint coating is utilized, a different buffer layer may be used instead of the SiO₂ buffer layer that is less dielectric and more conductive than the SiO₂ buffer layer. In some embodiments, the buffer layer may be, but is not limited to, zinc oxide, doped zirconium oxide, or combinations thereof.

For instance, as shown in FIG. 3A, an electrically conductive buffer layer 165 may be disposed on at least a portion of the first major surface 105A of cover glass 105, and an anti-fingerprint layer 170 may be disposed on the modified buffer layer 165. While FIG. 3A illustrates the conductive buffer layer 165 covering the entire first major surface 105A, it is to be understood that such a buffer layer may be disposed on only a portion of the first major surface, e.g., on a central or peripheral portion of the surface, or applied to any other portion of the surface in any desired pattern. The anti-fingerprint layer 170 may similarly be disposed to fully cover or only partially cover the conductive buffer layer 165 and/or first major surface 105A.

The conductive buffer layer 165 may comprise a traditional SiO₂ layer that has been modified to introduce impurities, to reduce oxygen content, or both. Alternatively, the conductive buffer layer 165 may comprise a non-traditional buffer layer material, such as zinc oxide or doped zirconium oxide. Exemplary elemental impurities can include, for example, hydrogen and alkali metals, such as Li, Na, K, Rb, Cs, and Fr, and combinations thereof. The conductive buffer layer 165 may, in some embodiments, be doped with such impurities, e.g., up to 5 wt % of impurities. By way of non-limiting example, the modified buffer layer 165 may comprise SiO₂, ZnO, and/or ZrO₂ and from about 0.0001 wt % to about 5 wt % of at least one elemental impurity, such as from about 0.001 wt % to about 4 wt %, from about 0.01 wt % to about 3 wt %, from about 0.1 wt % to about 2 wt %, or from about 0.5 wt % to about 1 wt %, including all ranges and subranges therebetween.

In some embodiments, a decorative ink may be applied to the backside of the cover glass, for example around its periphery to hide electrical leads and/or for aesthetic purposes. In such embodiments, the ink may be doped with conductive particles that can dissipate the static electricity built up on the cover glass. In some embodiments, the conductive particles include, but are not limited to, carbon, silver, and combinations thereof.

For example, as shown in FIG. 3B, an electrically conductive ink layer 175 may be disposed on at least a portion of the second major surface 105C of cover glass 105. Conductive ink layer 175 may, for example, be disposed around a peripheral region of the cover glass 105, such as forming a frame on the second major surface 105C of the cover glass 105. The entire frame of conductive ink is not visible in the cross-sectional view of FIG. 3B, but such an embodiment intended to fall within the scope of the disclosure. Additionally, the shape of the conductive ink layer 175 is not limited to square or rectangular frames, but may have any desired shape, which may be regular or irregular, and which may comprise one or more curvilinear edges. Ink in the conductive ink layer 175 can, in some embodiments, comprise pigments, such as white and black pigments, e.g., TiO₂ particles and other similar inorganic oxide particles. In addition, the modified ink layer 175 can comprise one or more conductive particles, e.g., carbon and/or conductive metals, such as silver, gold, copper, tin, platinum, and other like conductive metals. The concentration of conductive particles in the modified ink layer 175 may vary depending on the configuration, materials, but may range, for example, from about 0.1 wt % to about 10 wt %, such as from about 0.5 wt % to about 9 wt %, from about 1 wt % to about 8 wt %, from about 2 wt % to about 7 wt %, from about 3 wt % to about 6 wt %, or from about 4 wt % to about 5 wt %, relative to the total weight of the modified ink layer.

In some embodiments, when the cover glass is inserted into the electronic device, the edge of the cover glass may be protected with a gasket that is positioned between the periphery of the cover glass and the bezel of the electronic device's housing. In some embodiments, the gasket material may be electrically conductive so that it dissipates the static electricity built up on the cover glass. In some embodiments, the gasket material may comprise conductive polymers, conductive silicones, or other like materials. In some embodiments, the gasket may be grounded to improve the effectiveness in dissipating the static electricity. In some embodiments, the bezel may be a conductive material, for example metal, to improve the effectiveness in dissipating the static electricity.

For instance, as shown in FIG. 3C, an electrically conductive gasket 180 may be disposed on or otherwise in contact with at least one edge surface 105B of cover glass 105. Conductive gasket 180 may, for example, be disposed around a periphery of the cover glass 105, such as forming a frame or protective barrier around the cover glass 105. The entire periphery of cover glass 105 is not visible in the cross-sectional view of FIG. 3C, but gaskets extending completely around the periphery of the cover glass are intended to fall within the scope of the disclosure. The shape of the conductive gasket 180 may, in some embodiments, conform to the shape of the periphery of the cover glass 105 and, thus, may have any regular or irregular shape and/or may comprise one or more curvilinear edges. As depicted in FIG. 3C, the conductive gasket 180 may be disposed around only the cover glass 105 or, in other embodiments, the conductive gasket 180 may be in contact with other components in the display device, such as one or more of the adhesive layers, the polarizer, and so forth without limitation.

In some embodiments, the surface conductivity of the cover glass may be modified to prevent the build up of static electricity. In some embodiments, one or more surfaces of the cover glass may be modified by increasing the roughness of the cover glass surface. In some embodiments, the back side of the cover glass may be roughened and then adhered to the touch panel using an indexed matched optical adhesive to avoid undesirable optical affects resulting from the increased roughness of the cover glass. In some embodiments, the optical adhesive may be conductive and grounded to improve static charge dissipation.

For example, as shown in FIG. 3D, the second major surface of the cover glass 105 may be roughened to produce a modified second major surface 105C′. The at least one conductive element may thus include at least one roughened surface feature on the modified second major surface. Methods for roughening a surface of the cover glass can include mechanical methods, such as sand blasting, chemical methods, such as etching, and other techniques, such as laser damaging. The roughened surface features may have any shape or size as appropriate for a desired application. In some embodiments, the root mean square (RMS) roughness of the modified second surface 105C′ may be less than 5 microns, such as ranging from about 500 nm to about 5 μm, from about 700 nm to about 4 μm, from about 1 μm to about 3 μm, or from about 1.5 μm to about 2 μm, including all ranges and subranges therebetween. The cover glass 105 may be adhered to the polarizer 115 using first adhesive layer 110 which, in some embodiments, may be index matched to the cover glass 105.

In some embodiments, a layer of optically clear conductive polymer may be applied to the back side of the cover glass to dissipate the static electricity built up on the cover glass. In some embodiments, the conductive polymer may include, but is not limited to, a conductive, transparent, adhesive film, or a liquid optically clear adhesive, or combinations thereof. In some embodiments, conductive silver nanowires may be added to the adhesive to improve the electrical conductivity. In some embodiments, a conductive polymer layer may be disposed on either side of the polarizer to dissipate the static charge. In some embodiments, a conductive ITO (indium tin oxide) film may be disposed on either side of the polarizer to dissipate the static charge. In some embodiments, the ITO film may be formed using conventional techniques such as sputtering. In some embodiments, a polarizer with a lower electrical resistance may be used.

For instance, as shown in FIG. 3E, one or more conductive metal or metal oxide layers 185, 185′, and/or 185″, may be disposed on at least a portion of the second major surface 105C of the cover glass 105, on at least a portion of the first major surface 115A of the polarizer 115, on at least a portion of the second major surface 115C of the polarizer 115, or any combinations thereof. While FIG. 3E demonstrates an assembly comprising all three of conductive layers 185, 185′, and 185″ for illustrative purposes, it is to be understood that only one of such layers may be present or, in additional embodiments, only two of such layers may be incorporated into the device. Additionally, while layers 185 and 185″ are illustrated as covering all of the respective surfaces upon which they are deposited, while layer 185′ covers only a portion, it is to be understood that the shape of any of these layers may be modified to cover any desired portion of the surface in any desired pattern.

In some embodiments, one or more of conductive layers 185, 185′, and 185″ may be optically transparent and may cover all or a portion of a surface of the cover glass and/or polarizer. In other embodiments, one or more of conductive layers 185, 185′, and 185″ may not be optically transparent and may cover only a portion of a surface of the cover glass and/or polarizer. For example, the conductive layers 185, 185′, and 185″ may comprise a conductive metal layer, e.g., silver, copper, gold, tin, platinum, and the like. Such metals may be deposited by sputtering or, alternatively, may be applied to the surface as a solution or paste. Conductive layers 185, 185′, and 185″ may also comprise a conductive metal oxide layer, such as a TCO layer, e.g., ITO and the like. Depending on the optical transparency of the conductive metal or metal oxide layer, the layer may be applied to all or a portion of one or more surfaces of the cover glass and/or polarizer.

With reference to any of FIGS. 3A-E, one or both of first and second adhesive layers 110, 120 may, for example, be modified and/or replaced to provide a conductive polymer layer. For example, conductive particles or nanowires may be added to the adhesive layer, or the adhesive layer may otherwise be replaced with a conductive polymer layer, such as polyaniline. Of course, any of the conductive elements illustrated in FIGS. 3A-E may be used alone or in combination to dissipate static energy. For instance, a cover glass 105 comprising a modified second major surface 105C′ as illustrated in FIG. 3D may be combined with a conductive buffer layer 165 as illustrated in FIG. 3A, a conductive ink layer 175 as illustrated in FIG. 3B, a conductive gasket 180 as illustrated in FIG. 3C, a conductive metal or metal oxide layer 185 as illustrated in FIG. 3E, a first adhesive layer 110 and/or second adhesive layer 120 comprising a conductive polymer, and so forth without limitation.

According to various embodiments, at least one of the cover glass 105, first adhesive layer 110, second adhesive layer 120, RX sensor layer 125, color filter glass 130, pixel electrodes 150, TX/VCOM layer 155, and TFT glass 160 may be optically transparent. In other embodiments, at least one of the conductive buffer layer 165, antifingerprint layer 170, and conductive metal or metal oxide layer 185 may be optically transparent. As used herein, the term “transparent” is intended to denote that the component and/or layer has a transmission of greater than about 80% in the visible region of the spectrum (˜400-700nm). For instance, an exemplary component or layer may have greater than about 85% transmittance in the visible light range, such as greater than about 90%, or greater than about 95%, including all ranges and subranges therebetween. The first and second adhesive layers 110, 120 may comprise optically clear adhesives, which may be in the form of adhesive films or adhesive liquids. Non-limiting exemplary thicknesses of the first and/or second adhesive layers 110, 120 may range from about 50 μm to about 500 μm, such as from about 100 μm to about 400 μm, or from about 200 μm to about 300 μm, including all ranges and subranges therebetween. The RX sensor layer 125, pixel electrodes 150, and/or TX/VCOM layer 155 may comprise transparent conductive oxides (TCOs), such as indium tin oxide (ITO) and other like materials. The TX/VCOM layer may also comprise a conductive mesh, e.g., comprising metals such as silver nanowires or other nanomaterials such as graphene or carbon nanotubes.

In non-limiting embodiments, the cover glass 105, color filter glass 130, and/or the TFT glass 160 may comprise optically transparent glass sheets. The glass sheets can have any shape and/or size suitable for use in a display device, such as an LCD touch screen. For example, the glass sheet can be in the shape of a rectangle, square, or any other suitable shape, including regular and irregular shapes and shapes with one or more curvilinear edges.

According to various embodiments, the glass sheets can have a thickness of less than or equal to about 3 mm, for example, ranging from about 0.1 mm to about 2 mm, from about 0.3 mm to about 1.5 mm, from about 0.5 mm to about 1.2 mm, or from about 0.7 mm to about 1 mm, including all ranges and subranges therebetween. According to various embodiments, the glass sheets can have a thickness of less than or equal to 0.3 mm, such as 0.2 mm, or 0.1 mm, including all ranges and subranges therebetween. In certain non-limiting embodiments, the glass sheets can have a thickness ranging from about 0.3 mm to about 1.5 mm, such as from about 0.5 to about 1 mm, including all ranges and subranges therebetween.

The glass sheets may comprise any glass known in the art for use in a display, such as an LCD touch screen, including, but not limited to, soda-lime silicate, aluminosilicate, alkali-aluminosilicate, borosilicate, alkaliborosilicate, aluminoborosilicate, alkali-aluminoborosilicate, and other suitable glasses. The glass sheets may, in various embodiments, be chemically strengthened and/or thermally tempered. Non-limiting examples of suitable commercially available glasses include EAGLE XG®, Lotus™, Willow®, and Gorilla® glasses from Corning Incorporated, to name a few. Chemically strengthened glass, for example, may be provided in accordance with U.S. Pat. Nos. 7,666,511, 4,483,700, and 5,674,790, which are incorporated herein by reference in their entireties.

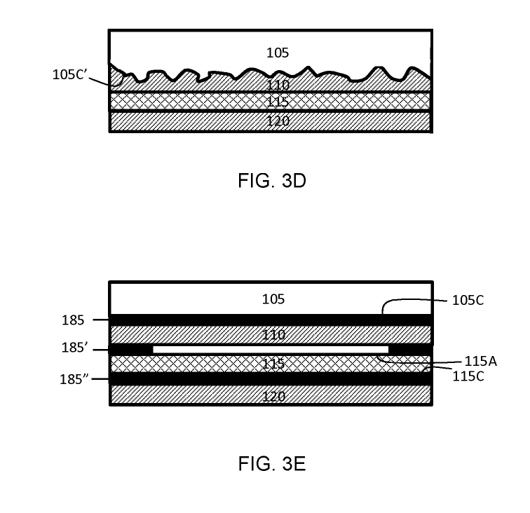

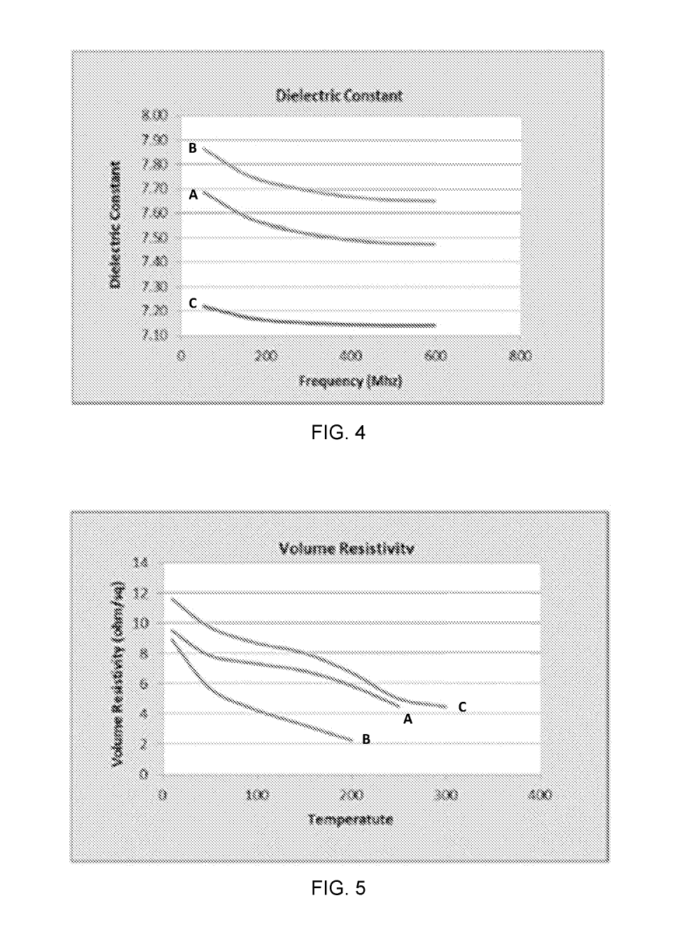

Referring to FIGS. 4-5, the physical properties of cover glasses having different compositions may affect the sensitivity of the cover sheet to static electricity. For instance, FIG. 4 depicts the dielectric constant of three cover glass sheets having different compositions as a function of frequency, and FIG. 5 depicts the bulk volume resistivity of those cover glass sheets as a function of temperature. The three cover glass sheets were not strengthened (either chemically or thermally). Glass A exhibited a generally higher dielectric constant curve in FIG. 4, which corresponded to a generally lower resistivity curve in FIG. 5. Similarly, glass C exhibited a generally lower dielectric constant curve in FIG. 4, which corresponded to a generally higher resistivity curve in FIG. 5. Glass B had dielectric constant and resistivity curves with generally moderate values that both fell between the respective curves for glasses A and C.

Cover glasses with higher resistivity (e.g., lower conductivity) have greater potential to develop static electricity when used with in cell hybrid displays, and therefore increased potential to develop mura due to electrostatic charge build up. As such, in order to use cover glasses with higher resistivity in in cell hybrid displays, it would be desirable to reduce electrostatic charge build up in such devices, e.g., by employing one or more of the embodiments disclosed herein. According to various embodiments of the disclosure, glass cover sheets comprising a glass having a higher bulk volume resistivity (lower bulk volume conductivity) may be included in the display devices disclosed herein without increasing the potential of the device to develop mura.

According to various embodiments, the display devices disclosed herein may quickly dissipate electrostatic charge on the cover glass. For instance, the cover glass in such display devices may have an electrostatic discharge decay time constant of less than about 1 second, such as less than about 0.5 seconds, e.g., ranging from about 0.1 seconds to about 1 second (such as 0.1, 0.2, 0.3, 0.4, 0.5, 0.6, 0.7, 0.8, 0.9, or 1 second). The decay time constant may be calculated as the amount of time it takes the electrostatic charge to decay by a factor of lie (about 36.8% of the original amount).

While the cover glasses disclosed herein are discussed in reference to in cell hybrid displays, such as LCD touch screens, it is to be understood that cover glass assemblies according to the instant disclosure may be used in any variety of electronic or display devices in which electrostatic charge may occur. As such, a cover glass assembly may include a cover glass sheet, an adhesive layer, and at least one electrically conductive element as disclosed herein. The adhesive layer may be disposed, for example, on a second major surface of the cover glass sheet and the at least one electrically conductive element may be disposed on either the first or second major surface of the cover glass sheet. An optional anti-fingerprint layer may also be disposed on the first major surface of the cover glass sheet in some embodiments. The cover glass assembly may, in various embodiments, have an electrostatic discharge decay time constant of less than about 1 second, such as less than about 0.5 seconds. The adhesive layer may be used to attach the cover glass assembly to any suitable display or electronic device.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a method or device that comprises A+B+C include embodiments where a method or device consists of A+B+C and embodiments where a method or device consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

1. A device comprising:
(a) a receive (RX) sensor layer;
(b) a transmit (TX) sensor layer;
(c) a cover glass;
(d) a polarizer positioned between the RX sensor layer and the cover glass; and
(e) at least one electrically conductive element disposed on at least one surface of the cover glass, at least one surface of the polarizer, or both.

2. The device of claim 1, wherein the at least one electrically conductive element is an electrically conductive buffer layer disposed on at least a portion of a first major surface of the cover glass.

3. The device of claim 2, wherein the electrically conductive buffer layer comprises:
(i) silica doped with impurities comprising hydrogen or alkali metals;
(ii) silica depleted of oxygen;
(iii) zinc oxide;
(iv) zirconium oxide doped with impurities comprising hydrogen or alkali metals; or
(v) combinations thereof.

4. The device of claim 1, wherein the at least one electrically conductive element comprises an electrically conductive ink layer disposed on at least a portion of a second major surface of the cover glass.

5. The device of claim 4, wherein the electrically conductive ink layer comprises at least one inorganic oxide doped with at least one electrically conductive particle chosen from carbon and electrically conductive metals.

6. The device of claim 1, wherein the at least one electrically conductive element comprises a gasket disposed on at least one edge surface of the cover glass, wherein the gasket comprises an electrically conductive material, and wherein the gasket is optionally grounded.

7. The device of claim 6, further comprising a metal bezel in contact with the gasket.

8. The device of claim 1, wherein the at least one electrically conductive element comprises an electrically conductive polymer layer disposed on at least a portion of a second major surface of the cover glass, at least a portion of a first major surface of the polarizer, at least a portion of a second major surface of the polarizer, or combinations thereof; and wherein the electrically conductive polymer layer is optionally grounded.

9. The device of claim 1, wherein the at least one electrically conductive element comprises at least one roughened surface feature disposed on at least a portion of a second major surface of the cover glass.

10. The device of claim 1, wherein the at least one electrically conductive element comprises an electrically conductive metal or metal oxide layer disposed on at least a portion of a second major surface of the cover glass, at least a portion of a first major surface of the polarizer, at least a portion of a second major surface of the polarizer, or combinations thereof.

11. The device of claim 1, comprising at least two electrically conductive elements chosen from the electrically conductive elements recited in claims 2, 4, 6, and 8-10.

12. The device of claim 1, further comprising a first adhesive layer positioned between the cover glass and the polarizer.

13. The device of claim 12, further comprising a second adhesive layer positioned between the polarizer and the RX sensor layer.

14. The device of claim 1, further comprising at least one of a liquid crystal layer, thin film transistor array, a color filter glass, and a color filter.

15. The device of claim 1, wherein the device is a liquid crystal touch-display with an in cell hybrid configuration.

16. The device of claim 1, wherein the cover glass has an electrostatic discharge decay time constant of less than about 1 second.

17. A cover glass assembly comprising:
a cover glass sheet comprising a first major surface and a second major surface;
an adhesive layer disposed on at least a portion of the second major surface;
an optional anti-fingerprint layer disposed on at least a portion of the first major surface; and
at least one electrically conductive element chosen from:
an electrically conductive buffer layer disposed on at least a portion of the first major surface,
an electrically conductive ink layer disposed on at least a portion of the second major surface,
an electrically conductive gasket disposed on at least one edge surface of the cover glass sheet,
an electrically conductive polymer layer disposed on at least a portion of the second major surface,
at least one roughened surface feature disposed on at least a portion of the second major surface, and
an electrically conductive metal or metal oxide layer disposed on at least a portion of the second major surface;
wherein the cover glass assembly has an electrostatic discharge decay time constant of less than about 1 second.

18. A method for reducing mura in a touch-display device, the method comprising:
(a) positioning a polarizer between a cover glass sheet and a receive (RX) sensor layer; and
(b) applying at least one electrically conductive element to at least one surface of the cover glass sheet, at least one surface of the polarizer, or both.

19. The method of claim 18, wherein step (b) comprises applying an electrically conductive buffer layer to at least a portion of a first major surface of the cover glass sheet.

20. The method of claim 18, wherein step (b) comprises applying an electrically conductive ink layer to at least a portion of a second major surface of the cover glass sheet.

21. The method of claim 18, wherein step (b) comprises applying an electrically conductive gasket to at least one edge surface of the cover glass sheet.

22. The method of claim 18, wherein step (b) comprises applying at least one of an electrically conductive polymer layer, an electrically conductive metal layer, or an electrically conductive metal oxide layer to at least a portion of a second major surface of the cover glass, at least a portion of a first major surface of the polarizer, at least a portion of a second major surface of the polarizer, or combinations thereof.

23. The method of claim 18, wherein step (b) comprises roughening at least a portion of a second major surface of the cover glass sheet.

24. (canceled)
